(19) United States
(12) Patent Application Publication
(10) Pub. No.: US 2014/0372213 A1
(43) Pub. Date: Dec. 18, 2014

(54) ADVOCATE ADVICE

(71) Applicant: Facebook, Inc., Menlo Park, CA (US)

(72) Inventors: Jeffrey Gipson, Hoboken, NJ (US); Derek Scott, Brooklyn, NY (US); Paul Adams, Dublin (IE); Kevin Knight, Menlo Park, CA (US); David Schatz, New York, NY (US)

(21) Appl. No.: 13/921,127

(22) Filed: Jun. 18, 2013

(51) Int. Cl. G06Q 30/02; G06Q 50/00

(52) U.S. Cl. CPC G06Q 30/0255; G06Q 50/01
USPC 705/14.53

(57) ABSTRACT

Systems and methods for creating connections for advocate advice are provided. Various embodiments of the present invention relate to identifying users as experts/advocates in a particular area and connecting the experts/advocates with users of a social network. The experts/advocates can be self-identified or identified through a selection process. For example, products owned by a particular user can be identified (e.g., manually or automatically), and the particular user can opt-in as an advocate for those products. In some embodiments, various rewards can be provided to encourage participation at different levels. The experts/advocates can provide recommendations based on subject matter selected by the user (e.g., twins, pregnancy, cancer, phone type, etc.) with or without any friendship connections. In addition, the experts/advocates can be recommended to users of the social network based one or more social signals.

### TECHNICAL FIELD

Various embodiments of the present invention generally relate to connecting members of a social network. More specifically, some embodiments of the present invention relate to creating connections for advocate advice.

### BACKGROUND

Users of social networking services may form connections, associations, or other relationships with other users based on real-life interactions, online interactions, or a wide variety of other bases. For example, users may choose to connect with others who are in the same geographic location, who have a common circle of friends, who have attended the same college or university, etc. Existing social networking systems provide limited mechanisms for finding such connections.

In some instances, for example, social networking systems provide individuals with access to an introduction mechanism. The introduction mechanism may be as simple as showing the profiles of matched individuals through listings, social network visualizations, or through context-aware match alerts and introduction management tools that aim to encourage interpersonal contact. Without doing a specific search for a user, it is a common challenge for users to locate other users with whom they may wish to form a connection. Identifying users for specific types of connections is almost impossible. As such, needs exist for improved techniques for identifying and connecting users.

### SUMMARY

Systems and methods are described for creating connections for advocate advice regarding a specified topic. In some embodiments, an advocate network can be generated that includes a set of advocates that are each associated with one or more topics. The advocate network can be accessible by members of a social network. Once the advocate network has been generated, requests from members of the social network to identify advocates from the advocate network having knowledge of a specified topic can be received. Then, a subset of advocates can be identified from the set of advocates that have expertise or experience with the specified topic. The subset of advocates can be presented to a user through a graphical user interface with profile information regarding the subset of advocates. In some cases, the subset of advocates can be prioritized based on an advocate influence rating. The user can submit a connection request within the graphical user interface to connect the user to a specific advocate. In some embodiments, communications between the user and the specific advocate can be facilitated.

In some embodiments, potential advocates can be identified from members of the social network. These potential advocates can be selectively targeted (e.g., using advertisements presented through the social network). For example, the embodiments of the system may use topic extraction within conversations or postings within the social network to identify potential advocates. Upon selection of the advertisement, the potential advocate can be directed to a signup page. The signup page can allow the potential advocate (i.e., the targeted member) to join the advocate network and become one of the set of advocates through a self-selection process. During the self-selection process, the potential advocate may identify one or more topics the potential advocate is willing to discuss and provide advice on. The potential advocate may be presented with various rewards for signing up and participating within the advocate network.

Embodiments of the present invention also include computer-readable storage media containing sets of instructions to cause one or more processors to perform the methods, variations of the methods, and other operations described herein.

In some embodiments, a system for connecting members of a social network with advocates can include a database, an application programming interface (API) server, an identification module, a permissions module, a graphical user interface (GUI) generation module, an advertisement module, and/or an information module. The database can have stored thereon a plurality of data about members, objects, and connections within a social network. The API server can receive requests to identify advocates participating in an advocate network based on a specified topic specified by a requestor. The advocates may have joined an advocate network by self-identifying with one or more topics. The identification module can access the advocate network and generate a set of advocates identified with the specified topic based on the members, objects, and connections within the social network. The permissions module can be communicably coupled to the identification module and configured to identify permissions set by each member regarding information about the set of advocates. The GUI generation module can receive the permissions and only present information about the subset of advocates that are in accordance with the permissions. The informational module can identify articles, videos, webpages, or research papers regarding the specified topic. This additional content can be directly presented to the user, or links to the content can be presented to the user.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a networked-based environment in which some embodiments of the present invention may be utilized;

FIG. 2 shows a block diagram with components of an advocate network that may be used with one or more embodiments of the present invention;

FIG. 3 is a flowchart with an example set of operations for connecting advocates with members of a social network;

FIG. 4 illustrates various steps within an advocate flow in accordance with one or more embodiments of the present invention;

FIG. 5 illustrates an example of a landing page that may be used in accordance with various embodiments of the present invention;

FIG. 6 illustrates various steps within a buyer flow in accordance with some embodiments of the present invention;

FIG. 7 illustrates various steps within an alternative buyer flow in accordance with one or more embodiments of the present invention;

FIGS. 8A-8B illustrate an example of a graphical user interface screen illustrating product highlights that may be used in various embodiments of the present invention;

FIG. 9 illustrates an example of a graphical user interface screen which may be used to check the status of referrals in accordance with some embodiments of the present invention;

FIG. 10 illustrates an example of a graphical user interface screen which may be used to identify and encourage various activities in accordance with various embodiments of the present invention;

FIG. 11 illustrates an example of a graphical user interface screen that allows the individual to set personalized goals and support friends that have set personalized goals in accordance with one or more embodiments of the present invention;

FIG. 12 illustrates an example of a graphical user interface screen that allows the individual to track the goals they previously set in accordance with some embodiments of the present invention;

FIG. 13 illustrates an example of a graphical user interface screen that allows advocates (or potential advocates) to self-identify with topics and even connect advocates with the same expertise in accordance with one or more embodiments of the present invention;

FIG. 14 is a block diagram of a system architecture of the social networking system with which some embodiments of the present invention may be utilized; and

FIG. 15 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to connecting members of a social network with individuals, advocates, or experts. More specifically, some embodiments of the present invention relate to creating connections for advocate advice. Experts/advocates in a particular area can be identified (e.g., self-identified) to create an advocate network. The experts/advocates can be connected with users of a social network who need advice about a particular topic (e.g., medical condition, electronic device, etc.). In accordance with various embodiments, the experts/advocates can be self-identified or identified through a selection process (e.g., topic extraction). For example, products owned (e.g., mobile device) by a particular user can be identified (e.g., manually or automatically), and the particular user can opt-in as an advocate for those products. In some embodiments, targeted advertising can be used to direct potential advocates to a registration page.

Through the registration page, information regarding a potential advocate's opinion and/or expertise may be solicited. In some embodiments, various rewards can be provided to encourage participation at different levels. The experts/advocates can provide recommendations based on subject matter selected by the user (e.g., twins, pregnancy, cancer, phone type, etc.) with or without any friendship connections. In addition to providing connections with experts, various embodiments of the present invention may identify additional material (e.g., article, webpages, research papers, videos, etc.) which may help the user. In some embodiments, the experts/advocates can be recommended to users of the social network based on one or more social signals.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Moreover, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical discs, compact disc read-only memories (CD-ROMs), magneto-optical discs, ROMs, random access memories (RAMs), erasable programmable read-only memories (EPROMs), electrically erasable programmable read-only memories (EEPROMs), application-specific integrated circuits (ASICs), magnetic or optical cards, flash memory, or other type of media/machine-readable medium suitable for storing electronic instructions.

### TERMINOLOGY

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present invention, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

### GENERAL DESCRIPTION

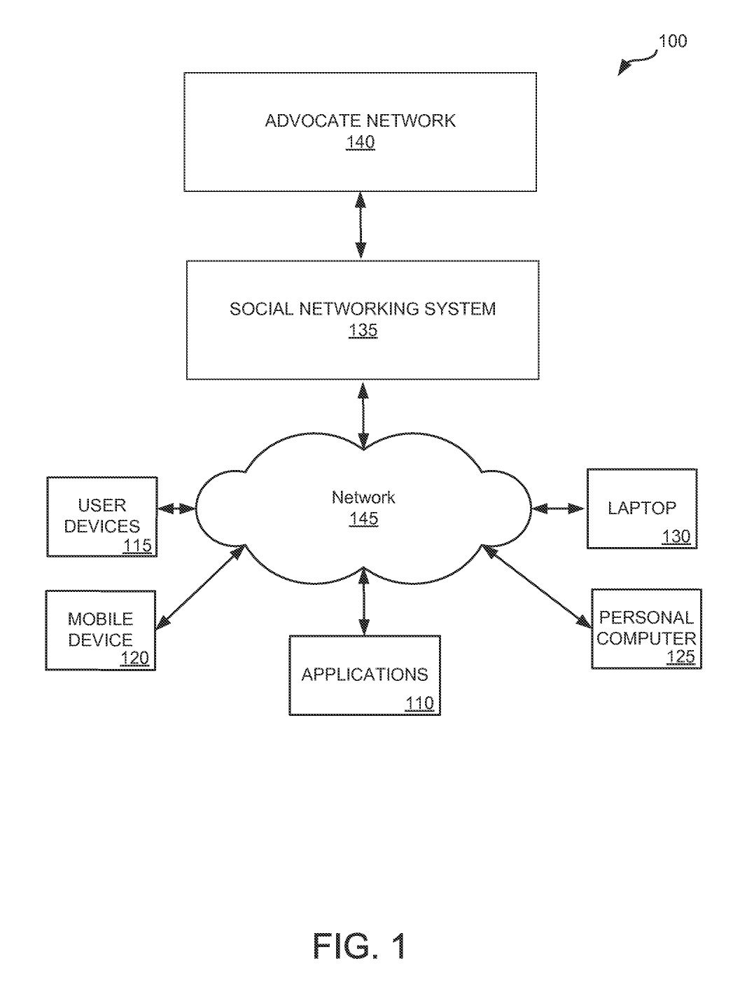

FIG. 1 illustrates an example of a networked-based environment 100 in which some embodiments of the present invention may be utilized. As illustrated in FIG. 1, various applications 110, user devices 115, mobile devices 120, personal computers 125, laptops 130, and/or other devices can be used to access social networking system 135 and/or advocate network 140. These devices and tools may use network 145 to submit and retrieve information from social networking system 135. User device 115 can be any computing device capable of receiving user input as well as transmitting and/or receiving data via the network 145. In one embodiment, user device 115 can be a conventional computer system, such as a desktop 125 or laptop computer 130. In another embodiment, user device 115 may be mobile device 120 having computer functionality, such as a personal digital assistant (PDA), mobile telephone, smart-phone or similar device. In one embodiment, user device 115 executes an application allowing a user of user device 115 to interact with the social networking system 135. For example, user device 115 can execute a browser application to enable interaction between the user device 115 and social networking system 135 via the network 145. In another embodiment, user device 115 interacts with social networking system 135 through an application programming interface (API) that runs on the native operating system of the user device 115, such as IOS® or ANDROID™.

User devices 115 can be configured to communicate via the network 145, which may comprise any combination of local area and/or wide area networks, using both wired and wireless communication systems. In one embodiment, network 145 uses standard communications technologies and/or protocols. Thus, network 145 may include links using technologies such as Ethernet, 802.11, worldwide interoperability for microwave access (WiMAX), 3G, 4G, CDMA, digital subscriber line (DSL), etc. Similarly, the networking protocols used on network 145 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 145 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

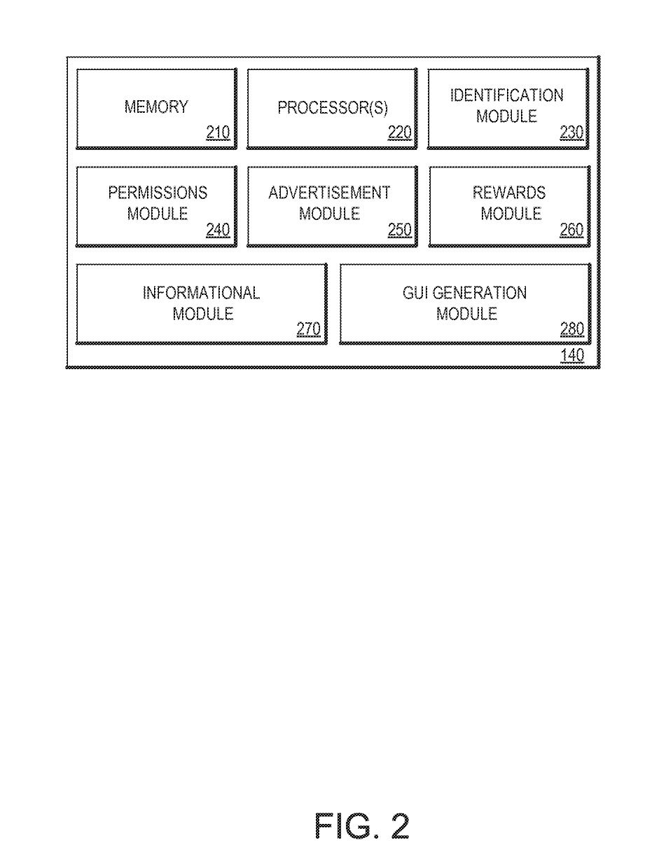

FIG. 2 shows a block diagram with components of an advocate network 140 that may be used with one or more embodiments of the present invention. According to the embodiments shown in FIG. 2, the system can include memory 210, one or more processors 220, identification module 230, permission module 240, advertisement module 250, rewards module 260, informational module 270, and graphical user interface (GUI) generation module 280. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, identification module 230 and advertisement module 250 can be combined into a single module for identifying potential advocates.

Memory 210 can be any device, mechanism, or populated data structure used for storing information. In accordance with some embodiments of the present invention, memory 210 can encompass any type of, but is not limited to, volatile memory, nonvolatile memory, and dynamic memory. For example, memory 210 can be random access memory, memory storage devices, optical memory devices, magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 210 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 210.

Memory 210 may be used to store instructions for running one or more applications or modules on processor(s) 220. For example, memory 210 could be used in one or more embodiments to house all or some of the instructions needed to execute the functionality of identification module 230, permissions module 240, advertisement module 250, rewards module 260, informational module 270, and/or GUI generation module 280.

Identification module 230 can generate a set of advocates that have knowledge regarding a specified topic supplied through a request from a connection application. The request may identify the user submitting the request and may identify the specified topic along with other information (e.g., geographical location, preferences, permissions, etc.). This information can be used in prioritizing or ranking advocates. In addition, other information contained within a social graph of the social network may be used to prioritize advocates. In some cases, the user may specify additional filter criteria for the selection of advocates such as age, location, life experiences (e.g., has twins), interests, medical experiences, goals, interests, and the like beyond that of the specified topic. Identification module 230 can generate the set of advocates based on the specified topic and other information about the members, objects, and connections within the social network and/or the advocate network. In some embodiments, identification module 230 may only generate the set of candidate users from friends of friends of the user submitting the request.

Permission module 240 can be communicably coupled to identification module 230 and configured to identify permissions set by each member, an advocate connecting application, advocates within an advocate network, and/or the social network. The permissions may include restrictions regarding information about the set of advocates that can be transmitted, shared, and/or used in identifying advocates. In some cases, only advocates that are friends or friends of friends of the user may be presented as possible connections.

Advertisement module 250 can generate advertisements requesting the members of the social network join the advocate network and share their expertise and/or experiences with other members. The advertisements generated by advertisement module 250 may be selectively targeted at members of the social network and/or customized based on a variety of information collected by the social network. For example, the social network may track the type of mobile device a member is using when the member accesses the social network. With the device information, advertisement module 250 can generate a customized advertisement asking the user to join the advocate network and share their experiences, likes, dislikes, and other opinions regarding the mobile device. As another example, topic extraction can used to determine topics within conversations between members. This information can be used to determine if a member may have knowledge about a specific topic and create customized advertisements and/or invitations to join the advocate network.

In some embodiments, when a member selects the advertisement they can be redirected to a signup page that allows the member to join the advocate network. The advocate network could be managed by the social network or by a third-party. In exchange for participation within the advocate network, one or more rewards may be granted by rewards module 260. For example, in exchange for becoming an advocate regarding a phone produced by a particular mobile phone manufacturer, advocates may receive earlier access to new models by the manufacturer, free or discounted phones, free mobile applications, free music, gift cards, earn points that can be exchanged for a variety of products, and/or other rewards. In some cases, the rewards may be based on an advocate's participation and/or influence within the advocate network. For example, longer and more helpful reviews may increase the amount of rewards. As another example, the more people that buy a product the advocate is supporting could also result in a higher level of rewards.

Informational module 270 can identify articles, videos, webpages, or research papers regarding the specified topic. This additional content can be directly or indirectly presented (e.g., through a GUI screen) to the user. In some embodiments, this additional information may be rated by advocates or members of the social network.

GUI generation module 280 can generate one or more graphical user interface screens. These screens can be used to display information (e.g., regarding the advocates and/or advertisements). In some embodiments, the graphical user interface screens can be used to join the advocate network, allow an advocate to self-identify with one or more topics, assign filter criteria, select and manage rewards, message advocates, message other members of the social networking system, and/or other activities.

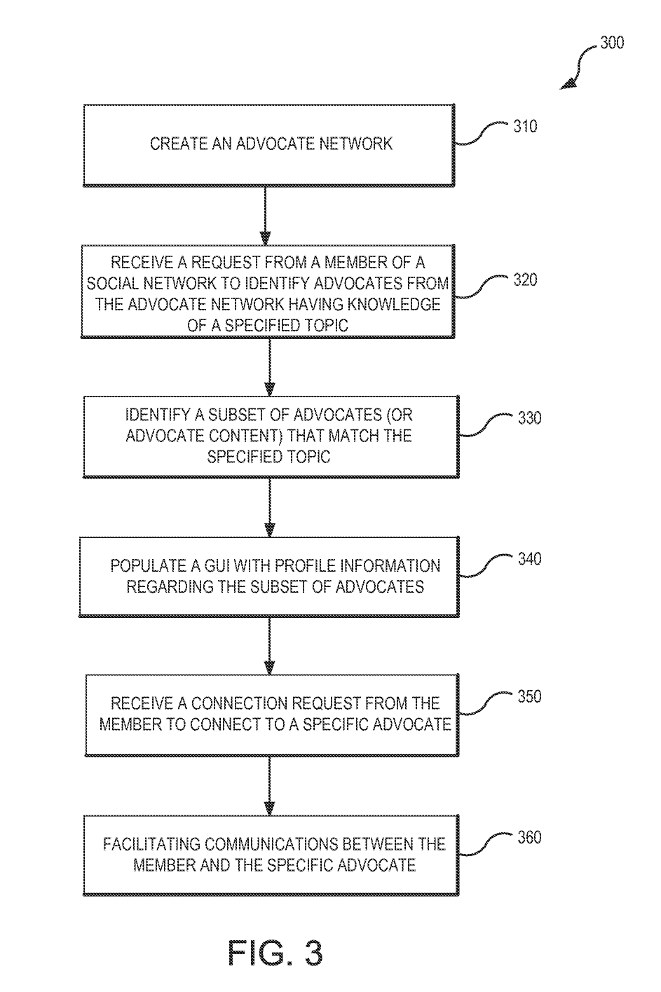

FIG. 3 is a flowchart with an example of a set of operations for connecting advocates with members of a social network. In accordance with various embodiments, the operations illustrated in FIG. 3 may be performed by identification module 230, advertisement module 250, GUI generation module 280, processor 220, and/or other system components. Creation operation 310 creates an advocate network. This may be done, for example, by allowing members of a social network that desire to share their knowledge to join an advocate network and self-select areas of expertise. The advocate network may use advertising module 250 to generate target advertisements or promotional material to encourage members to join the advocate network and self-identify areas of expertise.

Receiving operation 320 receives a request from a member of a social network to identify advocates having knowledge of a specific topic. Upon receiving the request, identification operation 330 can identify a subset of advocates (or advocate content such as written reviews or videos) that matches the specified topic. The subset of advocates (or advocate content) may be prioritized, weighted, or filtered based on connections within a social graph, advocate ratings, privacy settings, and/or other factors. In some embodiments, recommendations of a product or device may also be presented based on the most prevalent product or device in the member's network. For example, if the member entered a request for recommendations for a new phone or a new car, the system may generate a recommendation based on the most common devices or cars found within the member's social network. Profile information of the advocates can then be presented through a graphical user interface (e.g., generated by GUI generation module 280) with population operation 340.

The member can review the profile information of the advocates and/or advocate content and generate a connection request that is received during connecting operation 350. Facilitation operation 360 can then facilitate communications between the member and the specific advocate identified in the connection request. The communications could be through a private messaging system, a video chat, e-mail, etc.

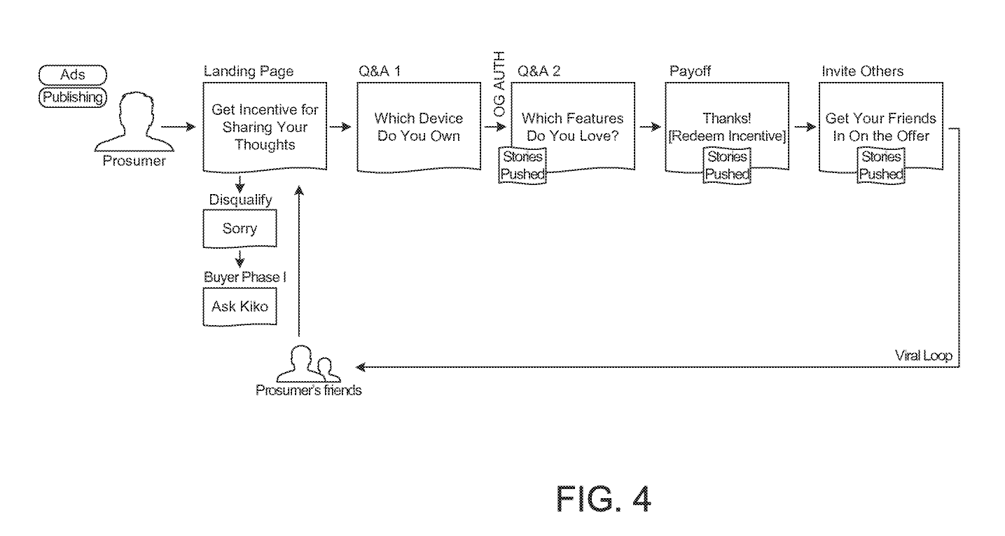

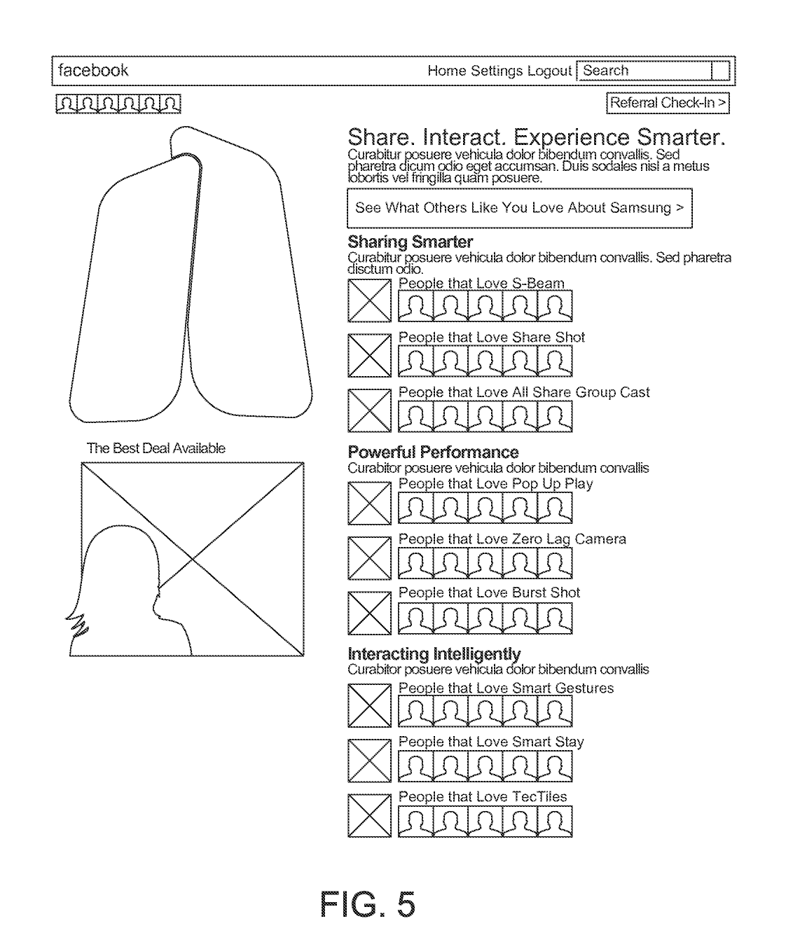

FIG. 4 illustrates various steps within an advocate flow in accordance with one or more embodiments of the present invention. As illustrated in FIG. 4, advertisements can be pushed to a potential advocates (e.g., prosumers) within a social network. The potential advocate can then be directed to a landing page (e.g., as illustrated in FIG. 5) that encourages the member to share their thoughts in exchange for an incentive and/or reward. A variety of questions may be used to determine if the potential advocate meets necessary prequalifications for becoming an advocate. For example, if the potential advocate is needed for recommending or answering questions about a device, the prequalification may be ownership of the device. In some embodiments, those potential advocates that do not meet the prequalifications may be linked to a page to learn more about a device (e.g., through connecting with an advocate) or other topic (e.g., a medical condition) and/or purchase a product or device.

If all of the prequalifications are met, the potential advocate can be presented with an authentication challenge (or registration). Upon successful authentication, a series of questions may be presented to the potential advocate. The questions may allow for a free-text response or allow for selection from one or more predetermined answers. The potential advocate can select from a variety of privacy and permission options regarding how this information may be shared. For example, potential advocate may allow the information to be shared with any member of the social network. In other cases, the potential advocate may elect to have some or all of the information shared to with friends or friends of friends as defined by a social graph of the network. Upon completion of the questions, rewards and/or incentives may be provided to a prosumer. In addition, the prosumers may be allowed to invite others to join and/or use the advocate network.

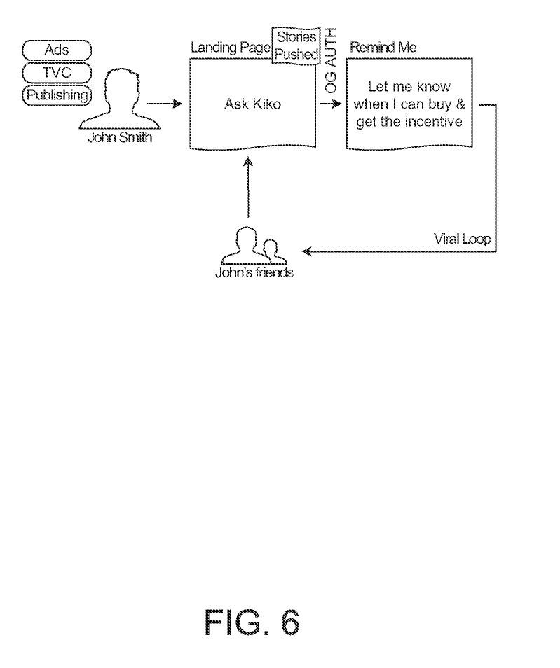

FIG. 6 illustrates various steps within a buyer flow in accordance with some embodiments of the present invention. As illustrated in FIG. 6, various targeted advertisements can be pushed to a member of a social network. The member can be directed to a landing page (e.g., by clicking on the advertisement or a link within the advertisement). At the landing page, the user can generate an advocate request for information about a specified topic (e.g., a product or medical condition). Some information (e.g., public advocate profiles) may be presented to the user before completion of an authorization challenge. Once the authorization challenge has been met, the user may be presented more detailed and/or customized advocate profiles along with additional information (e.g., links to third party reviews, articles, videos, etc.). In some cases, various suppliers of a product may allow for the product to be directly purchased.

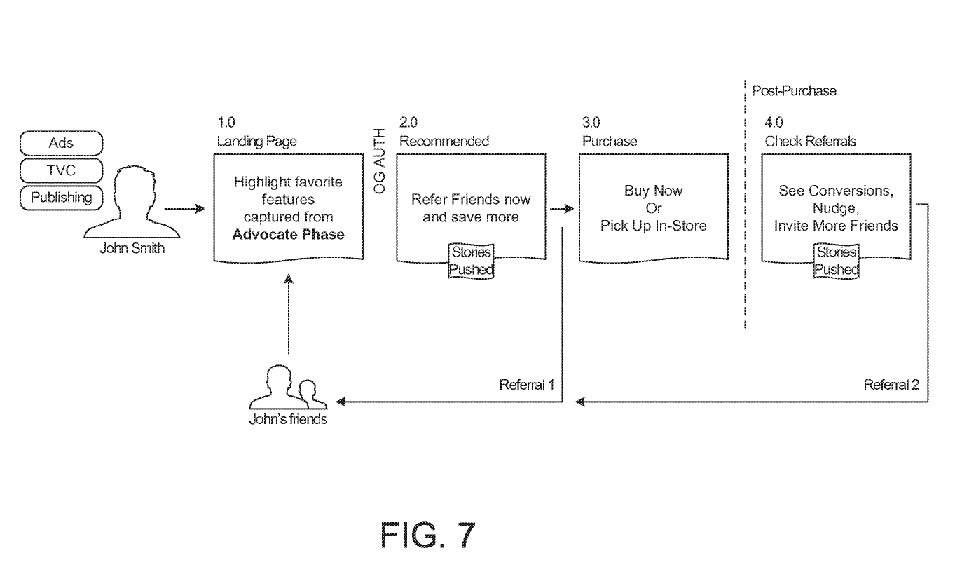

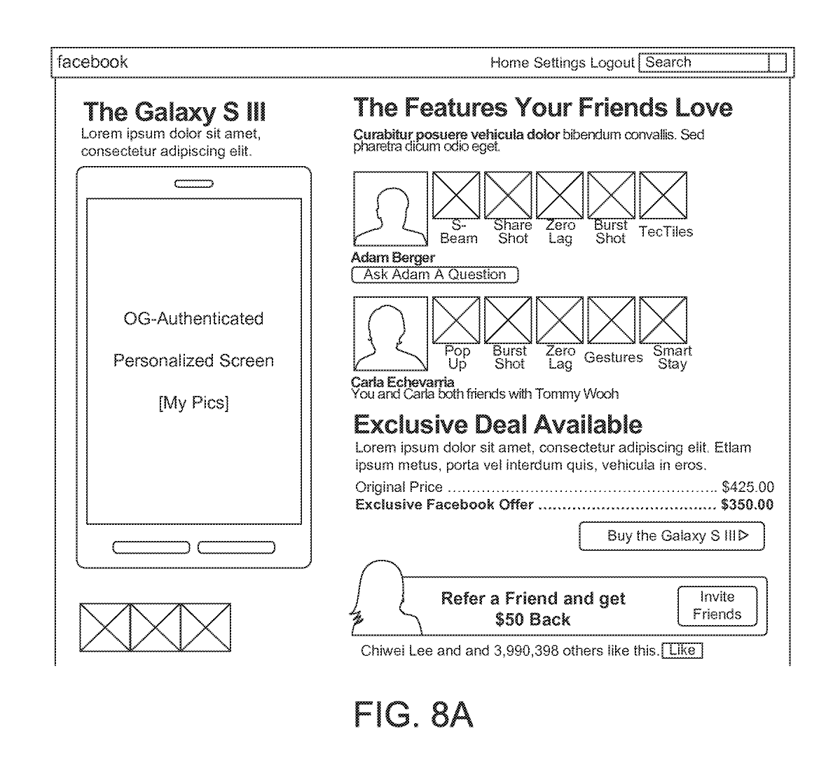

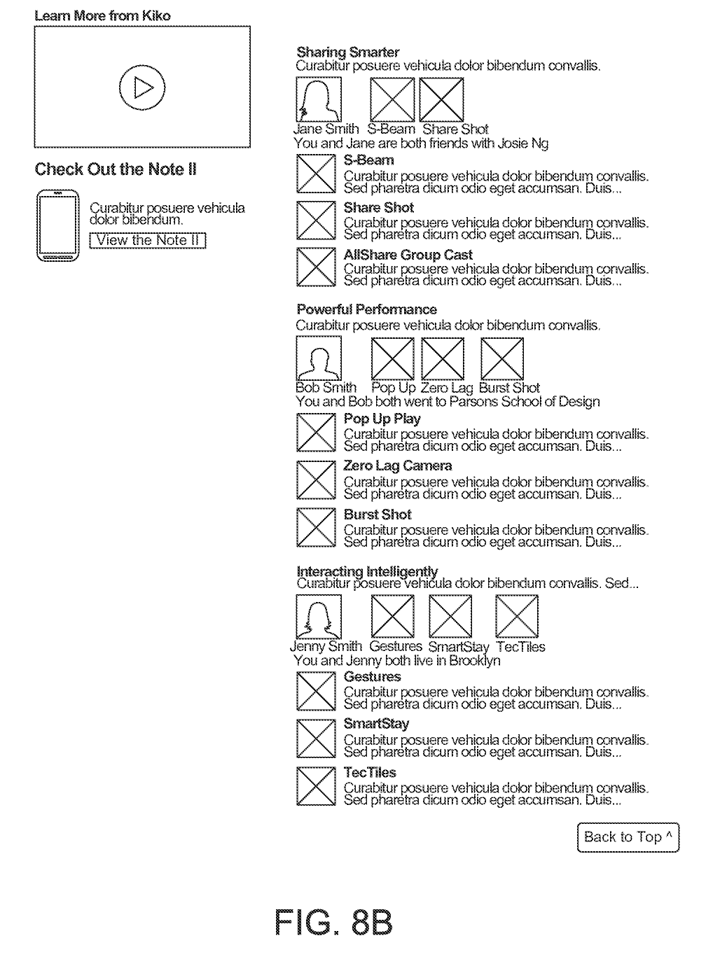

FIG. 7 illustrates various steps within an alternative buyer flow in accordance with one or more embodiments of the present invention. As illustrated in FIG. 7, various targeted advertisements can be pushed to a member of a social network. The user can be directed to a landing page (e.g., by clicking on the advertisement or a link within the advertisement). At the landing page (see, e.g., FIG. 5), various desirable features of a product can be highlighted possibly along with information about one or more advocates of the product. Some information (e.g., public advocate profiles, third-party advertisements, summaries of reviews, etc.) may be presented to the user before completion of an authorization challenge. Once the authorization challenge has been met, the user may be presented more detailed information and/or customized advocate profiles along with any additional third-party information (e.g., links to third party reviews, articles, videos, etc.). FIGS. 8A-8B illustrate a GUI screen illustrating product highlights that may be used in various embodiments of the present invention.

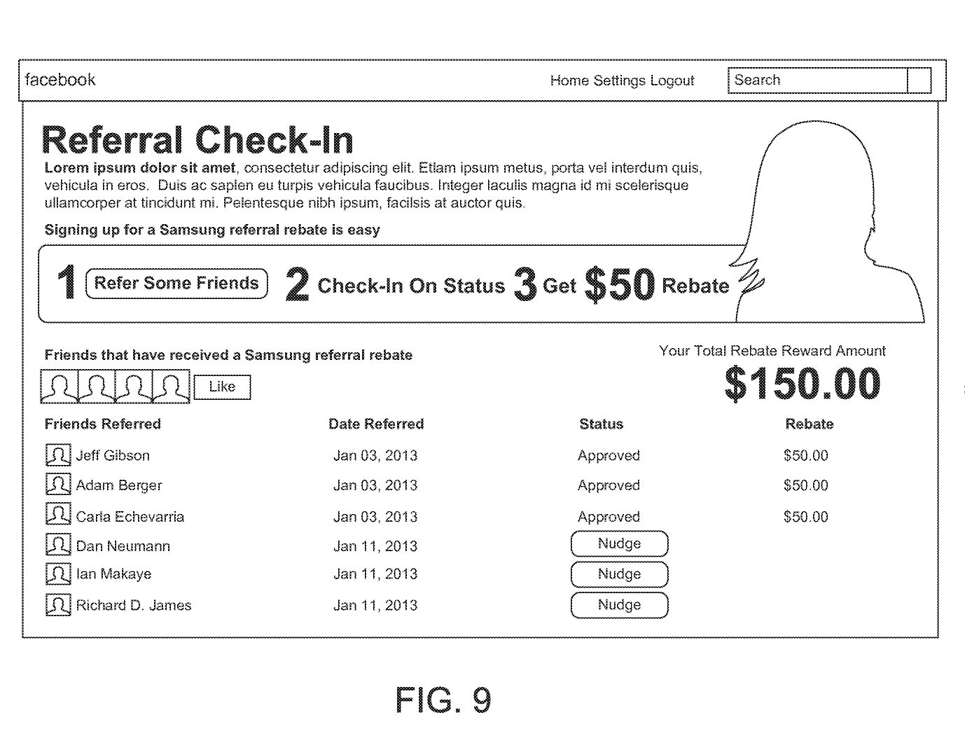

By referring a friend to the advocate network, the user may be able to save more on the product or receive other types of rewards. Once the user is ready, the user can purchase the product through an e-commerce interface. After the product is purchased, a post purchase flow can be initiated by various embodiments of the present invention to encourage the purchaser to invite more friends, become a stronger advocate of the product, initiate conversations regarding the product, etc. FIG. 9 illustrates an example of GUI screen which may be used to check the status of referrals in accordance with some embodiments of the present invention.

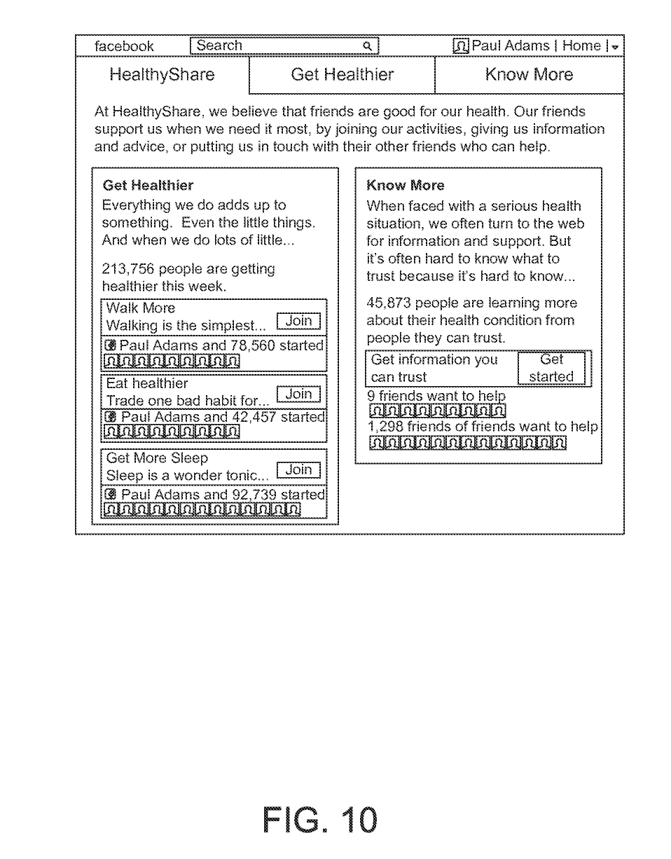

In addition to providing advocate networks for products, various embodiments of the present invention provide for advocate networks relating to non-product related information. For example, some embodiments provide advocate networks relating to finding advocates that can provide other information and/or support (e.g., regarding health-related issues). FIGS. 10-13 illustrate examples of various GUI screens (e.g., generated by GUI generation module 280) for connecting people on health-related issues. As described above, an advocate network can be created by identifying members of a social network to share their experiences and/or provide support. Targeted advertisements may be presented to encourage members to participate in the advocate network (e.g., by self-identifying with certain topics/experiences). During the registration process, the member can indicate whether they want to help just their friends or anyone. Again, the system allows the advocate to initiate invitations to invite others that might be experts.

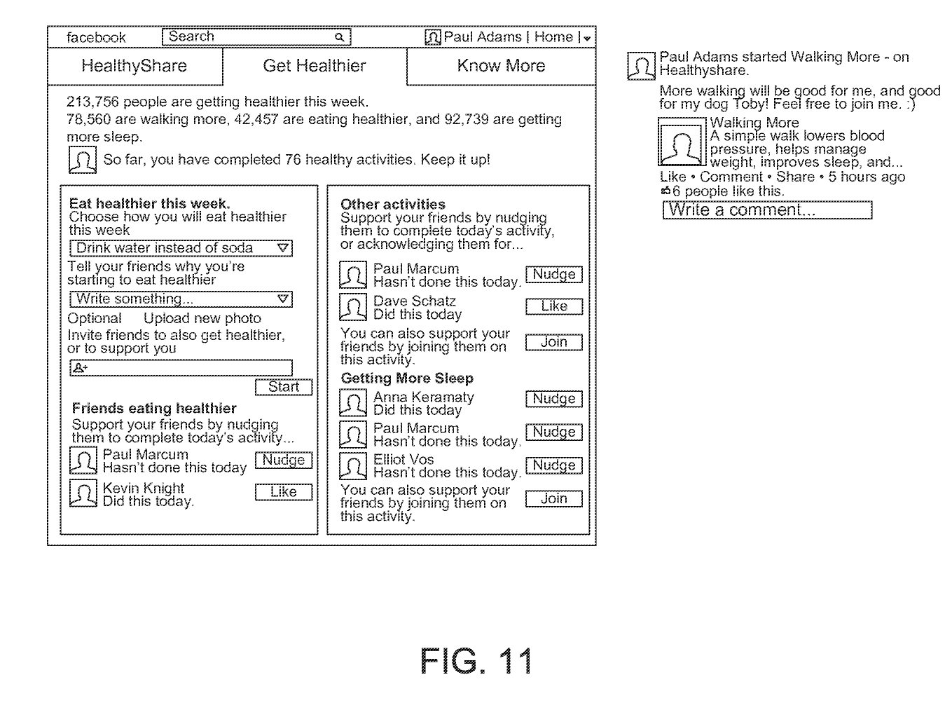

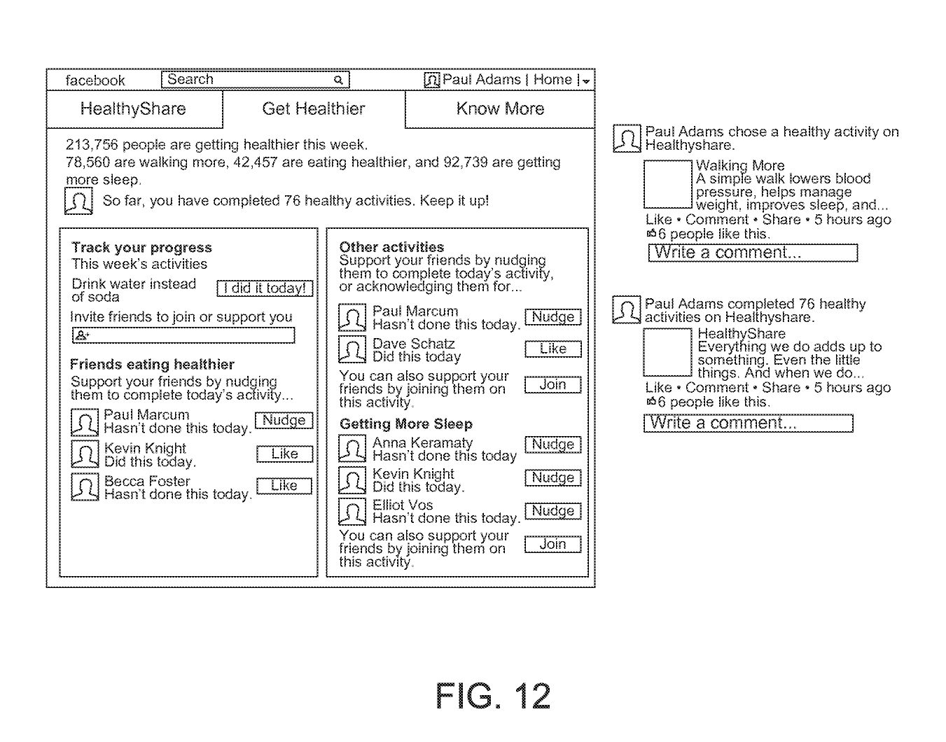

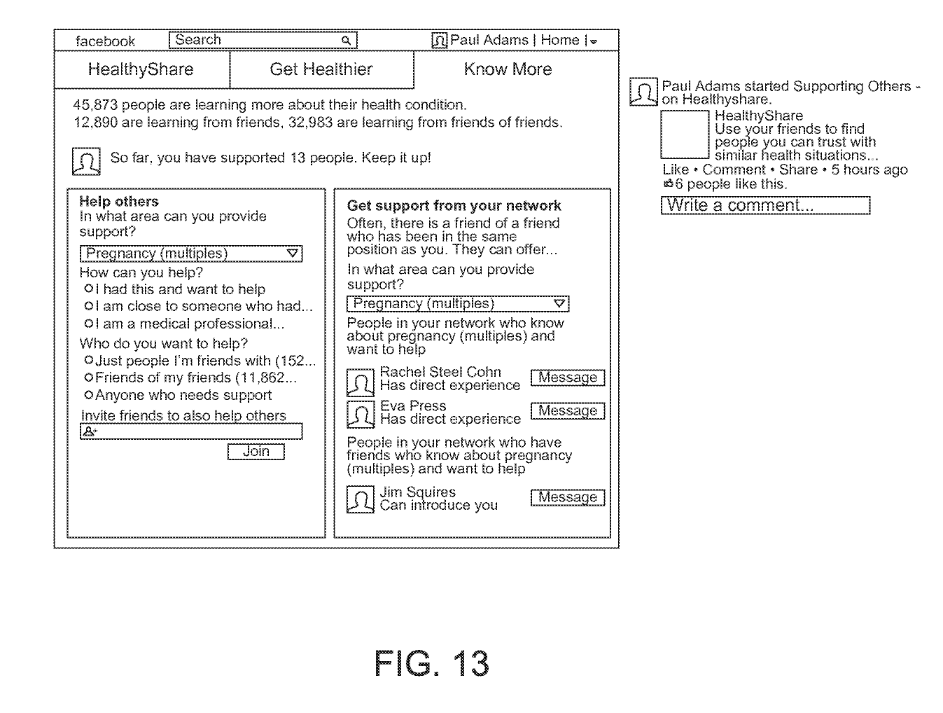

Some embodiments of the present invention may encourage activities to accomplish a task or goal. As illustrated in FIG. 10, the activities could include walking more, eating healthier, or getting more sleep. However, the activities may not be related to health-related issues in other embodiments. For example, the activities could revolve around job training or travel related issues (e.g., get vaccinated, get your passport, consider these destinations, consider these hotels, etc.). FIG. 11 illustrates an example of a GUI screen that allows the individual to set personalized goals and allows the individual to support friends that have set personalize goals through nudges, likes, scheduling joint activities, and the like. FIG. 12 illustrates an example of a GUI screen that allows the individual to track the goals they previously set. FIG. 13 illustrates an example of a GUI screen that allows advocates (or potential advocates) to self-identify with topics and even connect advocates with the same expertise.

### Social Networking System Architecture

As mentioned above, embodiments of the present invention can be utilized within a social networking system. Typically, a social networking system includes one or more computing devices storing user profiles associated with users and/or other objects as well as connections between users and other users and/or objects. In use, users join the social networking system and then add connections to other users or objects of the social networking system to which they desire to be connected. The users may be individuals or entities such as businesses, organizations, universities, or manufacturers. The social networking system allows its users to interact with each other as well as with other objects maintained by the social networking system. In some embodiments, the social networking system allows users to interact with third-party websites and financial account providers.

Based on stored data about users, objects, and connections between users and/or objects, the social networking system can generate and maintain a “social graph” comprising a plurality of nodes interconnected by a plurality of edges. Each node in the social graph represents an object or user that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system can modify edges connecting the various nodes to reflect the interactions.

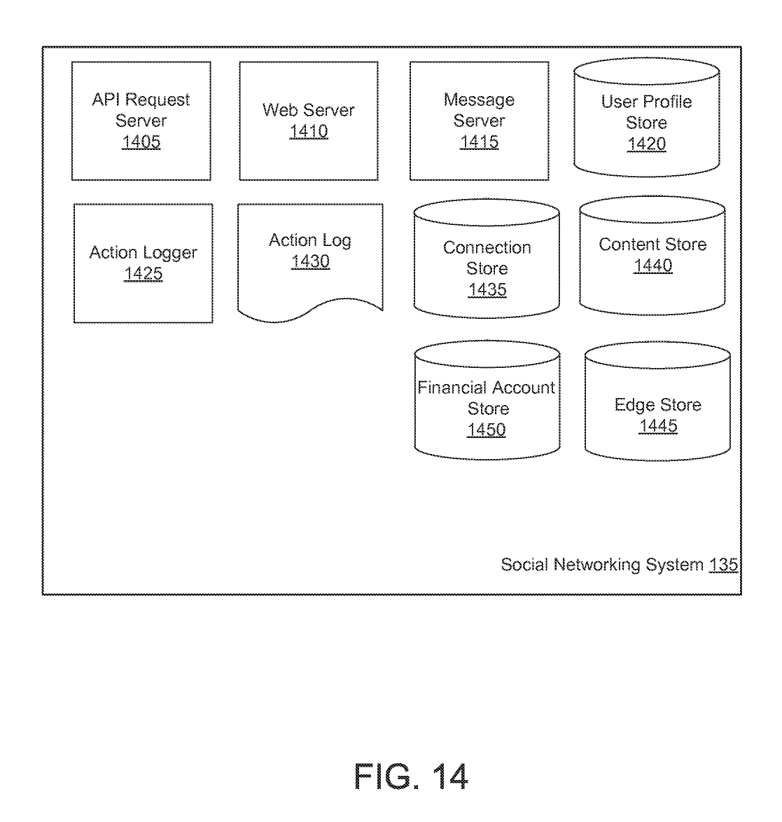

FIG. 14 is a block diagram of a system architecture of the social networking system 135 with which some embodiments of the present invention may be utilized. Social networking system 135 illustrated by FIG. 14 includes API request server 1405, web server 1410, message server 1415, user profile store 1420, action logger 1425, action log 1430, connection store 1435, content store 1440, edge store 1445, and financial account store 1450. In other embodiments, social networking system 135 may include additional, fewer, or different modules for various applications. Conventional components such as network interfaces, security mechanisms, load balancers, failover servers, management and network operations consoles, and the like are not shown so as to not obscure the details of the system architecture.

API request server 1405 allows other systems, user devices, or tools to access information from social networking system 135 by calling APIs. The information provided by the social network may include user profile information or the connection information of users as determined by their individual privacy settings. For example, a system, user device, or tools interested in accessing data connections within a social networking system may send an API request to social networking system 135 via a network. The API request is received at social networking system 135 by API request server 1405. API request server 1405 processes the request by submitting the access request to an access management system where access is determined and any data communicated back to the requesting system, user device, or tools via a network.

Web server 1410 links social networking system 135 via a network to one or more client devices; the web server serves web pages, as well as other web-related content, such as Java, Flash, XML, and so forth. The web server 1410 may communicate with the message server 1415 that provides the functionality of receiving and routing messages between social networking system 135 and client devices. The messages processed by message server 1415 can be instant messages, queued messages (e.g., email), text and SMS (short message service) messages, or any other suitable messaging technique. In some embodiments, a message sent by a user to another can be viewed by other users of social networking system 135, for example, by the connections of the user receiving the message. An example of a type of message that can be viewed by other users of the social networking system besides the recipient of the message is a wall post. In some embodiments, a user can send a private message to another user that can only be retrieved by the other user.

Each user of the social networking system 135 is associated with a user profile, which is stored in user profile store 1420. A user profile includes declarative information about the user that was explicitly shared by the user, and may also include profile information inferred by social networking system 135. In one embodiment, a user profile includes multiple data fields, each data field describing one or more attributes of the corresponding user of social networking system 135. The user profile information stored in user profile store 1420 describes the users of social networking system 135, including biographic, demographic, and other types of descriptive information, such as work experience, educational history, gender, hobbies, preferences, location, and the like. A user profile may also store other information provided by the user, for example, images or videos. In certain embodiments, images of users may be tagged with identification information of users of social networking system 135 displayed in an image. A user profile in user profile store 1420 may also maintain references to actions by the corresponding user performed on content items in content store 1440 and stored in the edge store 1445.

A user profile may be associated with one or more financial accounts, allowing the user profile to include data retrieved from or derived from a financial account. A user may specify one or more privacy settings, which are stored in the user profile, that limit information from a financial account that social networking system 135 is permitted to access. For example, a privacy setting limits social networking system 135 to accessing the transaction history of the financial account and not the current account balance. As another example, a privacy setting limits social networking system 135 to a subset of the transaction history of the financial account, allowing social networking system 135 to access transactions within a specified time range, transactions involving less than a threshold transaction amount, transactions associated with specified vendor identifiers, transactions associated with vendor identifiers other than specified vendor identifiers or any suitable criteria limiting information from a financial account identified by a user that is accessible by social networking system 135. In one embodiment, information from the financial account is stored in user profile store 1420. In other embodiments, it may be stored in financial account store 1450.

Action logger 1425 receives communications about user actions on and/or off social networking system 135, populating action log 1430 with information about user actions. Such actions may include, for example, adding a connection to another user, sending a message to another user, uploading an image, reading a message from another user, viewing content associated with another user, attending an event posted by another user, among others. In some embodiments, action logger 1425 receives, subject to one or more privacy settings, transaction information from a financial account associated with a user and identifies user actions from the transaction information. For example, action logger 1425 retrieves vendor identifiers from the financial account's transaction history and identifies an object, such as a page, in social networking system 135 associated with the vendor identifier. This allows action logger 1425 to identify a user's purchases of products or services that are associated with a page, or another object, in content store 1440. In addition, a number of actions described in connection with other objects are directed at particular users, so these actions are associated with those users as well. These actions are stored in action log 1430.

Action log 1430 may be used by social networking system 135 to track user actions on social networking system 135, as well as external websites that communicate information to social networking system 135. Users may interact with various objects on social networking system 135, including commenting on posts, sharing links, and checking-in to physical locations via a mobile device, accessing content items in a sequence or other interactions. Information describing these actions is stored in action log 1430. Additional examples of interactions with objects on social networking system 135 included in action log 1430 include commenting on a photo album, communications between users, becoming a fan of a musician, adding an event to a calendar, joining a group, becoming a fan of a brand page, creating an event, authorizing an application, using an application and engaging in a transaction. Additionally, action log 1430 records a user's interactions with advertisements on social networking system 135 as well as other applications operating on social networking system 135. In some embodiments, data from action log 1430 is used to infer interests or preferences of the user, augmenting the interests included in the user profile and allowing a more complete understanding of user preferences.

Action log 1430 may also store user actions taken on external websites and/or determined from a financial account associated with the user. For example, an e-commerce website that primarily sells sporting equipment at bargain prices may recognize a user of social networking system 135 through social plug-ins that enable the e-commerce website to identify the user of social networking system 135. Because users of social networking system 135 are uniquely identifiable, e-commerce websites, such as this sporting equipment retailer, may use the information about these users as they visit their websites. Action log 1430 records data about these users, including webpage viewing histories, advertisements that were engaged, purchases made, and other patterns from shopping and buying. Actions identified by action logger 1425 from the transaction history of a financial account associated with the user allow action log 1430 to record further information about additional types of user actions.

In some embodiments, social networking system 135 further stores data describing one or more connections between different users in the connection store 1435. The data describing one or more connections can include a list of connections, a date each connection (i.e., friendship) was made, etc. The connections may be further defined by users, allowing users to specify their relationships with other users. For example, the connections allow users to generate relationships with other users that parallel the users' real-life relationships, such as friends, co-workers, partners, and so forth. In one embodiment, the connection specifies a connection type based on the type of relationship. Examples of the type of relationship include family, friend, colleague, etc. Users may select from predefined types of connections, or define their own connection types as needed. Some or all of this information may also be stored as edge objects in edge store 1445.

Content store 1440 stores content items associated with a user profile, such as images, videos or audio files. Content items from content store 1440 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social network system by displaying content related to users, objects, activities, or functionalities of social networking system 135. Examples of social networking content items include suggested connections or suggestions to perform other actions, media provided to, or maintained by, social networking system 135 (e.g., pictures or videos), status messages or links posted by users to the social networking system, events, groups, pages (e.g., representing an organization or commercial entity), and any other content provided by, or accessible via, the social networking system.

Content store 1440 also includes one or more pages associated with entities having user profiles in user profile store 1420. An entity is a non-individual user of social networking system 135, such as a business, a vendor, an organization or a university. A page includes content associated with an entity and instructions for presenting the content to a social networking system user. For example, a page identifies content associated with the entity's user profile as well as information describing how to present the content to users viewing the brand page. Vendors may be associated with pages in content store 1440, allowing social networking system users to more easily interact with the vendor via social networking system 135. A vendor identifier is associated with a vendor's page, allowing social networking system 135 to identify the vendor and/or to retrieve additional information about the vendor from user profile store 1420, action log 1430 or from any other suitable source using the vendor identifier. In some embodiments, the content store 1440 may also store one or more targeting criteria associated with stored objects and identifying one or more characteristics of a user to which the object is eligible to be presented.

In one embodiment, edge store 1445 stores the information describing connections between users and other objects on social networking system 135 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in social networking system 135, such as expressing interest in a page on the social networking system, sharing a link with other users of the social networking system, and commenting on posts made by other users of the social networking system. Edge store 1445 stores edge objects that include information about the edge, such as affinity scores for objects, interests, and other users. Affinity scores may be computed by social networking system 135 over time to approximate a user's affinity for an object, interest, and other users in social networking system 135 based on the actions performed by the user. Multiple interactions between a user and a specific object may be stored in one edge object in edge store 1445, in one embodiment. In some embodiments, connections between users may be stored in user profile store 1420, or user profile store 1420 may access edge store 1445 to determine connections between users.

### Exemplary Computer System Overview

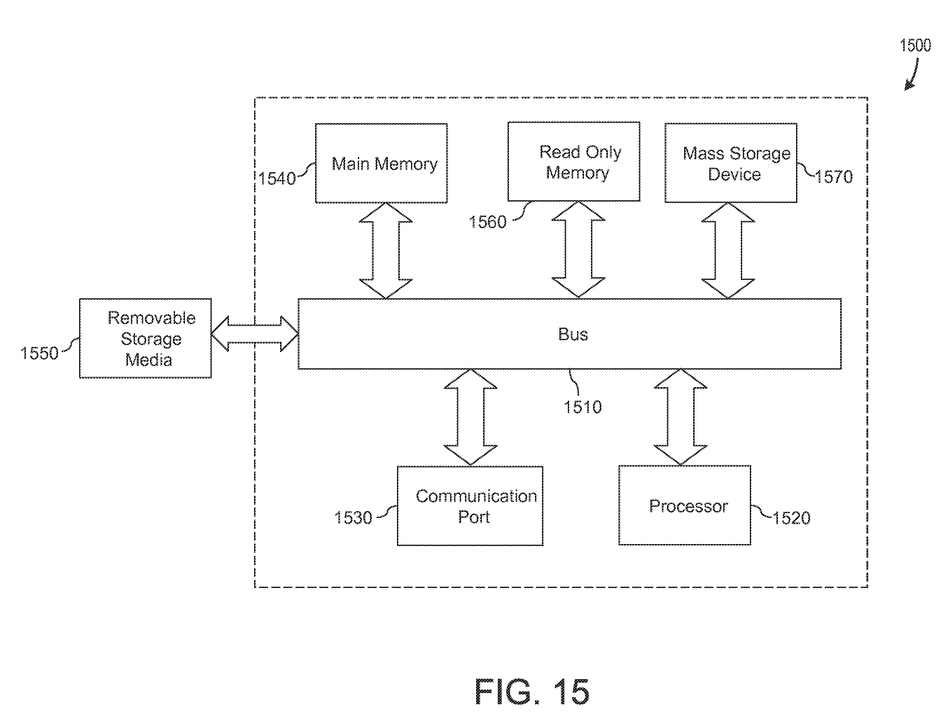

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 15 is an example of a computer system 1500 with which embodiments of the present invention may be utilized. According to the present example, the computer system includes a bus 1510, at least one processor 1520, at least one communication port 1530, a main memory 1540, a removable storage media 1550, a read only memory 1560, and a mass storage 1570.

Processor(s) 1520 can be any known processor, such as, but not limited to, ARM or x86-type processors, such as an Intel® lines of processors; AMD® lines of processors; or Motorola® lines of processors. Communication port(s) 1530 can be any of an RS-232 port for use with a modem-based dialup connection, a 10/100 Ethernet port, or a Gigabit port using copper or fiber. Communication port(s) 1530 may be chosen depending on a network such as a Local Area Network (LAN), Wide Area Network (WAN), or any network to which the computer system 1500 connects. The communication port 1530 may also encompass wireless communications components, such as an IEEE 802.11, 3G/4G or other wireless transceiver.

Main memory 1540 can be Random Access Memory (RAM) or any other dynamic storage device(s) commonly known in the art. Read only memory 1560 can be any static storage device(s) such as Programmable Read Only Memory (PROM) chips for storing static information such as instructions for processor 1520.

Mass storage 1570 can be used to store information and instructions. For example, hard disks such as the Adaptec® family of SCSI drives, an optical disc, an array of disks such as RAID, such as the Adaptec family of RAID drives, or any other mass storage devices may be used.

Bus 1510 communicatively couples processor(s) 1520 with the other memory, storage and communication blocks. Bus 1510 can be a PCI/PCI-X or SCSI based system bus depending on the storage devices used.

Removable storage media 1550 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for connecting users of a social networking system. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof. Therefore, the above description should not be taken as limiting the scope of the invention, which is defined by the appended claims.

What is claimed is:

1. A method comprising
generating an advocate network accessible by members of a social network, wherein the advocate network includes a set of advocates that are each associated with one or more topics;
receiving a request from a first member of the social network to identify advocates from the advocate network having knowledge of a specified topic, wherein the first member of the social network has agreed to participate with the advocate network;
identifying, using a social graph from the social network, a subset of advocates from the set of advocates that match the specified topic;
populating a graphical user interface with profile information regarding the subset of advocates;
receiving a connection request within the graphical user interface to connect the first member to a specific advocate; and
facilitating communications between the first member and the specific advocate.

2. The method of claim 1, wherein generating the advocate network includes selectively targeting members of the social network by presenting targeted advertisements.

3. The method of claim 2, further comprising:
receiving a selection of the targeted advertisement from a targeted member; and
presenting a signup page that allows the targeted member to join the advocate network and become one of the set of advocates through a self-selection process that includes identifying the one or more topics to be associated with the targeted member.

4. The method of claim 3, further comprising presenting a reward to the targeted member for joining the advocate network.

5. The method of claim 2, wherein selectively targeting the member of the social network includes using topic extraction or device identification for targeting the member.

6. The method of claim 1, further comprising identifying articles, videos, webpages, or research papers regarding the specified topic to present to the first member.

7. The method of claim 1, wherein the one or more topics include medical conditions or electronic devices.

8. The method of claim 1, further comprising prioritizing the subset of advocates within the graphical user interface screen based on an advocate influence rating.

9. A system comprising:
a processor;
a database having stored thereon a plurality of data about members, objects, and connections within a social network;
an application programming interface (API) server to receive requests to identify advocates based on a specified topic, wherein the advocates have joined an advocate network by self-identifying with one or more topics;
an identification module to access the advocate network and generate, using the processor, a set of advocates identified with the specified topic based on the members, objects, and connections within the social network;
a permissions module communicably coupled to the identification module and configured to identify permissions set by each advocate regarding information that can be shared within the social network; and
a graphical user interface generation module configured to generate, using the processor, a graphical user interface screen to present a profile of the set of advocates in accordance with the permissions set by each advocate.

10. The system of claim 9, further comprising an advertisement module configured to generate advertisements requesting the members of the social network join the advocate network.

11. The system of claim 9, wherein the identification module only generates the set of advocates from friends and friends of friends of members submitting the requests.

12. The system of claim 9, further comprising a rewards module to determine one or more rewards based on participation within the advocate network.

13. The system of claim 9, further comprising an informational module to identify articles, videos, webpages, or research papers regarding the specified topic.

14. A non-transitory computer-readable storage medium containing a set of instructions to cause one or more processors to:
generate an advocate network accessible by members of a social network, wherein the advocate network includes a set of advocates that are each associated with one or more topics;
receive a request from a first member of the social network to identify advocates from the advocate network having knowledge of a specified topic;
identify, using a social graph from the social network, a subset of advocates from the set of advocates that match the specified topic;
populate a graphical user interface with profile information regarding the subset of advocates;
receive a connection request within the graphical user interface to connect the first member to a specific advocate; and
facilitate communications between the first member and the specific advocate.

15. The non-transitory computer-readable storage medium of claim 14, wherein the set of instructions further cause the one or more processors to generate the advocate network by selectively targeting members of the social network by presenting targeted advertisements.

16. The non-transitory computer-readable storage medium of claim 15, wherein the set of instructions further cause the one or more processors to:
receive a selection of the targeted advertisements from a targeted member; and
present a signup page that allows the targeted member to join the advocate network and become one of the set of advocates through a self-selection process that includes identifying the one or more topics to be associated with the targeted member.

17. The non-transitory computer-readable storage medium of claim 16, wherein the set of instructions further cause the one or more processors to present a reward to the targeted member for joining the advocate network.

18. The non-transitory computer-readable storage medium of claim 15, wherein the set of instructions further cause the one or more processors to selectively target the member of the social network using topic extraction or device identification.

19. The non-transitory computer-readable storage medium of claim 14, wherein the one or more topics include medical conditions or electronic devices.

20. The non-transitory computer-readable storage medium of claim 14, wherein the set of instructions further cause the one or more processors to prioritize the subset of advocates within the graphical user interface screen based on an advocate influence rating.
